(19) United States
(12) Patent Application Publication
(10) Pub. No.: US 2009/0294624 A1
(43) Pub. Date: Dec. 3, 2009

(54) Guide Element

(75) Inventors: Mario Bechtold, Hemhofen (DE); Bernd Gromoll, Baiersdorf (DE); Stefan Nunninger, Erlangen (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Hausgerate GmbH, Munchen (DE)

(21) Appl. No.: 12/084,732

(22) PCT Filed: Oct. 26, 2006
(86) PCT No.: PCT/EP2006/067796

§ 371 Date: Jul. 22, 2009

(30) Foreign Application Priority Data
Nov. 9, 2005 (DE) 10 2005 053 837.1

(51) Int. Cl. F16M 13/00

(52) U.S. Cl. 248/580

(57) ABSTRACT

A guide element, which has an independent rigidity in each of three spatial directions and in which great length modifications in relation to the geometric dimensions are achieved by suitable 3-D structures, enabling the durability of the element to be maintained over its entire service life. This permits the production of small spring elements.

The invention relates to a guide element for linear drives, linear compressors or similar, as claimed in the preamble of claim 1.

The carriage, especially of a linear motor, must be held on a predefined track for correct operation. Depending on the stroke of the movement, different measures—such as springs, sliding guides or such like—can be used. It is important for the guide to be able to move the carriage in its stroke over the lifetime of the motor, i.e. for the guide to have a durable design. Furthermore the guide must be able to accept the transverse forces occurring during movement and must impede useful movement as little as possible.

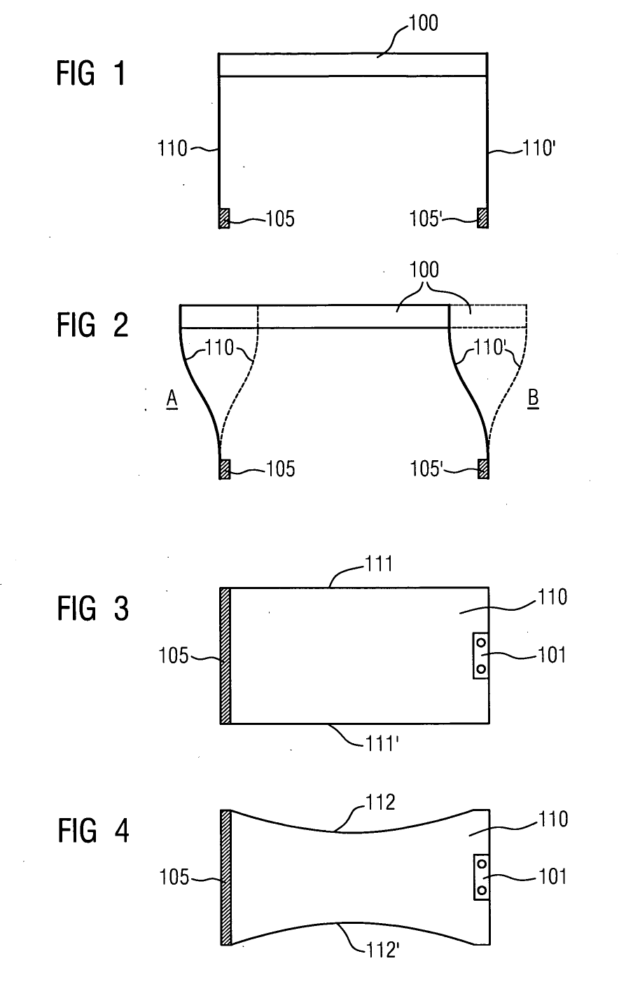

In the prior art such guides are implemented by two-dimensional leaf springs, an arrangement which is illustrated on the basis FIG. 1 and described in detail further below. So that these leaf springs are durable, the tension in each leaf spring may not exceed a value which is dependent on the material. For a required spring stiffness his produces a spring thickness dependent on the material and from this in turn the dimension of the spring is calculated from the maximum permitted tension values. A spring defined in this way, for a stroke of +/−10 mm, has a minimum length of appr. 10 cm. This means that the spring definitively determines the overall dimension of the system structure.

Using this as its starting point, the object of the invention is to create an improved guide element.

The object is inventively achieved by the features of claim 1. Further developments are specified in the subclaims.

The subject matter of the invention is a three-dimensional guide element with structures in which, in three spatial axes, independently selectable parameters, such as especially the stiffness are possible.

With the invention an arrangement can be created in which the springs can be made smaller. In particular the durability of the springs now advantageously no longer depends directly on their dimensions. The stiffness of the springs is preferably selected relatively freely in the x and y direction, with the stiffness being minimal in the z direction.

Further details and advantages of the invention emerge from the description of the figures or of exemplary embodiments with reference to the drawing in conjunction with the claims given below.

The figures show

FIG. 1 an arrangement of a linear drive with a two-dimensional leaf spring,

FIG. 2 the arrangement in accordance with FIG. 1 in the deflected state,

FIG. 3 the view from above of two alternate leaf springs for use in FIG. 1.

FIGS. 4 to 7 three different arrangements of a spring acting in three dimensions.

FIGS. 1 to 4 show leaf springs corresponding to the prior art. In each of FIGS. 1 to 4 is a carriage able to be moved in a linear manner is labeled 100. The carriage 100 is guided by two leaf springs 110 and 110′ which are fixed at their free end under permanently tension in mounts 105 and 105′ and are attached to the carriage by elements 101.

In accordance with FIG. 2 two end positions A and B of the carriage 100, which depend on the stiffness of the spring, are produced with such an arrangement.

Two variants of the leaf spring can be seen in the overhead view depicted in FIGS. 3 and 4. In the version in accordance with FIG. 3 the leaf spring 110 is embodied with rectangular surfaces with straight edge contours 111 or 111′, whereas in the version in accordance with FIG. 4 the leaf spring 110 has concave edge contours 112, 112′. This means that the loading can be kept almost constant over the length of the spring.

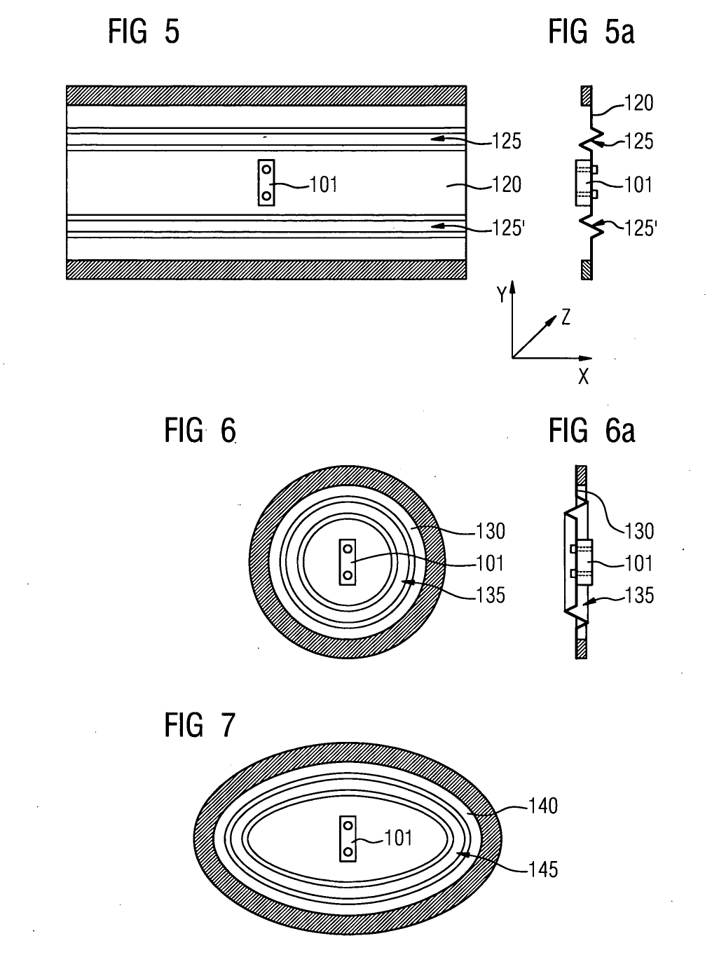

FIG. 5 shows a new form of a spring 120 with the stiffness being influenced in three dimensions by corrugations. To do this the previous spring arrangement—as shown above in FIG. 1/2—is modified: The spring 110 is turned through 90° mirrored in the middle and provided with one or more indentations, which will be referred to below as corrugations, of a freely-selectable shape, i.e. especially round or angular, preferably triangular. The corrugations 125 produce a three-dimensionally shaped arrangement in the two springs 120.

The corrugations 125 make it possible for the spring arrangement 120 to change its length, without great stresses arising in the spring material as a result. This means that the durability of the spring remains high although the dimensions of the spring are smaller. The required change in the length of the spring is produced as a function of the stroke of the carriage. The thickness and number of the corrugations 125 is selected accordingly. The distance between two corrugations 125, 125′ can be constant over the length of the corrugations or can vary. This allows the stiffness to be predetermined accordingly over the length of the corrugations 125.

The “new form” in accordance with FIG. 5 or 6 is the ideal solution for the case in which a spring force merely acts in the x direction, but no force acts in the y direction. If transverse forces act both in the x direction and also in the y direction, a “new” form” as depicted in FIG. 7 is a good solution. In this case the symmetrical form 3 in accordance with FIG. 6 accepts the same size forces in the in x and y direction respectively, whereas the form in accordance with FIG. 7 is ideally suited for unequal transverse forces.

The spring arrangements in accordance with the alternate FIGS. 5 to 7 can be made from any material, for example metal, plastic, composite materials, with suitable means such as impregnated paper, fibers, etc. The actual selection of the materials is made according to the respective requirements for elasticity, stiffness and costs.

1-9. (canceled)

10. A guide element for linear drives, linear compressors, or the like, the guide element comprising:
at least two components configured to be coupled to a linear drive, linear compressor, or the like, each component having independent stiffnesses in the three spatial directions and each component being capable, via at least one of a suitable three-dimensional configuration thereof or edge contours, of handling changes in length in relation to the geometrical dimensions, wherein durability of the components is achievable.

11. The guide element as claimed in claim 10, wherein each component is operable to guide, in a substantially wear-free manner, a part along a linear path.

12. The guide element as claimed in claim 10, wherein each component has a rectangular configuration with predetermined edge contours.

13. The guide element as claimed in claim 12, wherein each component has corrugations formed in the edge contours.

14. The guide element as claimed in claim 13, wherein the corrugations have a round shape.

15. The guide element as claimed in claim 13, wherein the corrugations have an angular shape, preferably a triangular shape.

16. The guide element as claimed in claim 10, wherein each component has a round configuration.

17. The guide element as claimed in claim 10, wherein each component has an oval configuration.
